(19) United States
(12) Patent Application Publication
(10) Pub. No.: US 2026/0339008 A1
(43) Pub. Date: Oct. 29, 2026

(54) OPTICAL FILTER AND IMAGING DEVICE

(71) Applicant: AGC INC., Tokyo (JP)

(72) Inventors: Takashi NAGATA, Haibara-gun (JP); Kazuhiko SHIONO, Koriyama-shi (JP); Motoshi NAKAYAMA, Chiyoda-ku (JP)

(73) Assignee: AGC INC., Tokyo (JP)

(21) Appl. No.: 19/650,426

(22) Filed: Apr. 17, 2026

(30) Foreign Application Priority Data
Apr. 22, 2025 (JP) 2025-071014

(51) Int. Cl. G02B 5/28; G02B 1/02

(52) U.S. Cl. CPC G02B 5/281; G02B 1/02

(57) ABSTRACT

An optical filter includes, in this order, a first dielectric multilayer film; an ytterbium-containing glass substrate; and a second dielectric multilayer film, and the optical filter satisfies the following spectral characteristics (I-i) to (I-v), and an average reflectance RI[930-960(5deg)AVE] at wavelengths of from 930 to 960 nm is 60% or more.
(I-i) An average transmittance at wavelengths of from 450 to 800 nm at an angle of incidence of 0 degrees is 90% or more.
(I-ii) A maximum transmittance at wavelengths of from 830 to 860 nm at an angle of incidence of 0 degrees is 80% or more.
(I-iii) A maximum transmittance at wavelengths of from 830 to 860 nm at an angle of incidence of 35 degrees is 80% or more.
(I-iv) A minimum transmittance at wavelengths of from 930 to 960 nm at an angle of incidence of 0 degrees is 0.2% or less.
(I-v) A minimum transmittance at wavelengths of from 930 to 960 nm at an angle of incidence of 35 degrees is 0.2% or less.

### CROSS-REFERENCE TO RELATED APPLICATIONS

This application claims priority from Japanese Patent Application No. 2025-071014, filed on Apr. 22, 2025, the entire disclosure of which is incorporated herein by reference.

### TECHNICAL FIELD

The present disclosure relates to an optical filter and an imaging device.

### RELATED ART

The applications of imaging devices using solid-state imaging elements have expanded to include devices that perform imaging regardless of day or night, such as surveillance cameras and vehicle-mounted cameras. In such devices, it is necessary to acquire a (color) image based on visible light and a (monochrome) image based on infrared light, respectively.

For this reason, the use of optical filters, so-called dual-bandpass filters, which have a function of selectively transmitting specific near-infrared light in addition to a near-infrared cut filter function for transmitting visible light and faithfully reproducing an image based on the visible light, has been studied.

Patent Document 1 discloses a near-infrared cut filter including an optical glass based on a glass composition containing at least Yb₂O₃ and B₂O₃ as essential components.

In addition, Patent Document 2 discloses an optical filter that can transmit light having wavelengths of from 840 to 850 nm and block light having wavelengths of from 930 to 950 nm.

### PRIOR ART DOCUMENTS

### Patent Documents

Patent Document 1: International Publication No. WO 2022/255336
Patent Document 1: International Publication No. WO 2023/210476

### SUMMARY OF THE INVENTION

### Technical Problem

In recent years, since laser light including a portion of wavelengths of from 800 to 1000 nm is used in a sensor in the imaging field, there is a demand for an optical filter capable of transmitting near-infrared light in such a sensing region.

In addition, in an optical filter having a dielectric multilayer film, since an optical film thickness of the dielectric multilayer film changes depending on an angle of incidence of light, a change in a spectral curve such as a spectral transmittance curve or a spectral reflectance curve depending on the angle of incidence is a problem. For example, as an angle of incidence of light increases, a wavelength range having high reflectance shifts toward a shorter wavelength side, and as a result, the reflection efficiency may decrease in a region that is originally intended to be blocked. Such a phenomenon is more likely to occur as the angle of incidence increases. In a case in which such a filter is used, light incident on a solid-state imaging element may be affected by an angle of incidence. Since use under a high angle-of-incidence condition is assumed with recent reduction in the height of a camera module, there is a demand for an optical filter that is hardly affected by the angle of incidence.

For example, in a case in which the shift amount of the spectral curve is large only in a region switching from the near-infrared light transmission region to the near-infrared light blocking region, the amount of transmitted near-infrared light changes depending on the angle of incidence, and a ratio of captured light amount of visible light and infrared light in a solid-state imaging element also changes depending on the angle of incidence. As a result, there is a concern that color reproducibility of a (color) image based on visible light or reproducibility of a (monochrome) image based on infrared light is affected.

For example, in a case in which an imaging device having a sensing region for visible light and near-infrared light around 850 nm and a sensing device using near-infrared light around 940 nm as a light source are mounted in combination in a certain device, a component derived from the light source around 940 nm may appear as stray light in a (color) image based on visible light or a (monochrome) image based on infrared light generated by the imaging device. In recent years, there is a case where a 3D sensing device using near-infrared light around 940 nm as a light source is mounted also on a smartphone or the like, and light from such a device may also become stray light. Therefore, from the viewpoint of removing stray light, it may be desired to block near-infrared light around 940 nm in a sensing region for light having wavelengths of from 800 to 1000 nm.

However, in the optical filter described in Patent Document 1 or 2, light blocking performance around 940 nm may not necessarily be sufficient in some cases.

The present disclosure has been made in view of the above conventional circumstances, and an object of the disclosure is to provide an optical filter having excellent transmissivity of visible light and near-infrared light in the vicinity of 850 nm, excellent blocking performance of near-infrared light in the vicinity of 940 nm, and a small shift amount of a spectral curve even at a high angle of incidence, and an imaging device using the optical filter.

### Solution to Problem

Specific means for achieving the above-described object are as follows.
<1> An optical filter, comprising, in this order: a first dielectric multilayer film; an ytterbium-containing glass substrate; and a second dielectric multilayer film, the optical filter satisfying the following spectral characteristics (I-i) to (I-v):
   (I-i) an average transmittance T[450-800(0deg)AVE] at wavelengths of from 450 to 800 nm in a spectral transmittance curve at an angle of incidence of 0 degrees is 90% or more,
   (I-ii) a maximum transmittance T[830-860(0deg)MAX] at wavelengths of from 830 to 860 nm in a spectral transmittance curve at an angle of incidence of 0 degrees is 80% or more,
   (I-iii) a maximum transmittance T[830-860 (35deg)MAX] at wavelengths of from 830 to 860 nm in a spectral transmittance curve at an angle of incidence of 35 degrees is 80% or more,
   (I-iv) a minimum transmittance T[930-960(0deg)MIN] at wavelengths of from 930 to 960 nm in a spectral transmittance curve at an angle of incidence of 0 degrees is 0.2% or less, and
   (I-v) a minimum transmittance T[930-960 (35deg)MIN] at wavelengths of from 930 to 960 nm in a spectral transmittance curve at an angle of incidence of 35 degrees is 0.2% or less,
   wherein, in a case in which at least one of a first dielectric multilayer film side or a second dielectric multilayer film side is a direction of incidence side, in a spectral reflectance curve at an angle of incidence of 5 degrees, an average reflectance RI[930-960(5deg)AVE] at wavelengths of from 930 to 960 nm is 60% or more.
<2> The optical filter according to <1>, satisfying the following spectral characteristics (I-vi) and (I-vii):
   (I-vi) in a spectral transmittance curve at an angle of incidence of 0 degrees, a wavelength IR50_{L} (0deg) at which a transmittance is 50% is in a range of from 860 to 900 nm, and
   (I-vii) in a spectral transmittance curve at an angle of incidence of 35 degrees, a wavelength IR50_{L} (35deg) at which a transmittance is 50% is in a range of from 850 to 900 nm.
<3> The optical filter according to <2>, wherein an absolute value of a difference between IR50_{L} (0deg) and IR50_{L} (35deg) is 20 nm or less.
<4> The optical filter according to any one of <1> to <3>, wherein, in a case in which at least one of the first dielectric multilayer film side or the second dielectric multilayer film side is the direction of incidence side, in a spectral reflectance curve at an angle of incidence of 5 degrees, an average reflectance RI[930-960(5deg)AVE] at wavelengths of from 930 to 960 nm is 80% or more.
<5> The optical filter according to any one of <1> to <4>, wherein an absolute value of a difference between T[830-860(0deg)MAX] and T[830-860 (35deg)MAX] is 10% or less.
<6> The optical filter according to any one of <1> to <5>, wherein an absolute value of a difference between a minimum optical density OD[930-960(0deg)] at wavelengths of from 930 to 960 nm at an angle of incidence of 0 degrees and a minimum optical density OD[930-960 (35deg)] at wavelengths of from 930 to 960 nm at an angle of incidence of 35 degrees, is 1.00 or less.
<7> The optical filter according to any one of <1> to <6>, wherein the ytterbium-containing glass substrate contains, in terms of mol % on an oxide basis, from 0.1 to 50 mol % of SiO₂, from 15 to 40 mol % of B₂O₃, from 0 to 15 mol % of P₂O₅, and from 20 to 60 mol % of Yb₂O₃.
<8> The optical filter according to any one of <1> to <7>, wherein a thickness of the ytterbium-containing glass substrate is from 0.4 to 1.0 mm.
<9> The optical filter according to any one of <1> to <8>, further comprising: a resin layer containing a dye having a maximum absorption wavelength of from 370 to 440 nm between the ytterbium-containing glass substrate and the second dielectric multilayer film.
<10> The optical filter according to <9>, wherein:
   a wavelength IR50ₛ(0deg) at which a transmittance is 50% falls within a range of from 390 to 440 nm in a spectral transmittance curve at an angle of incidence of 0 degrees,
   a wavelength IR50ₛ(35deg) at which a transmittance is 50% falls within a range of from 390 to 440 nm in a spectral transmittance curve at an angle of incidence of 35 degrees, and
   an absolute value of a difference between IR50ₛ(0deg) and IR50ₛ(35deg) is 2 nm or less.
<11> An imaging device, comprising the optical filter according to any one of <1> to <10>.

### Advantageous Effects of Invention

According to the disclosure, there are provided an optical filter having excellent transmissivity of visible light and near-infrared light in the vicinity of 850 nm, excellent blocking performance of near-infrared light in the vicinity of 940 nm, and a small shift amount of a spectral curve even at a high angle of incidence, and an imaging device using the optical filter.

### BRIEF DESCRIPTION OF THE DRAWINGS

FIG. 1 is a cross-sectional view of an optical filter 1A;

FIG. 2 is a cross-sectional view of an optical filter 1B;

FIG. 3 is a diagram showing spectral transmittance curves of the optical filter of Example 8 at an angle of incidence of 0 degrees (0 deg) and an angle of incidence of 35 degrees (35 deg); and

FIG. 4 is a diagram showing spectral reflectance curves of the optical filter of Example 8 at an angle of incidence of 5 degrees in a case in which a first dielectric multilayer film side (first side) and a second dielectric multilayer film side (second side) are set as direction of incidence sides.

### DETAILED DESCRIPTION OF THE INVENTION

In the disclosure, those numerical ranges that are expressed with “to” each denote a range that includes the numerical values stated before and after “to” as the minimum value and the maximum value, respectively.

In a set of numerical ranges that are stated stepwisely in the disclosure, the upper limit value or the lower limit value of a numerical range may be replaced with the upper limit value or the lower limit value of other numerical range. Further, in a numerical range stated in the disclosure, the upper limit or the lower limit of the numerical range may be replaced with a relevant value indicated in any of Examples.

In the disclosure, a combination of two or more preferred embodiments is a more preferred embodiment.

In the disclosure, the amount of each component means, unless otherwise specified, the total amount of a plurality of substances when two or more substances corresponding to that component are present.

In the disclosure, “transmittance” refers to measured transmittance.

In the disclosure, the transmittance of, for example, 90% or more in a specific wavelength range means that the transmittance does not fall below 90% over the entire wavelength range, that is, the minimum transmittance is 90% or more in the wavelength range. Similarly, the transmittance of, for example, 1% or less in a specific wavelength range means that the transmittance does not exceed 1% over the entire wavelength range, that is, the maximum transmittance is 1% or less in the wavelength range. An average transmittance in a specific wavelength range is an arithmetic average of transmittances at every 1 nm in the wavelength range.

In the disclosure, an average reflectance in a specific wavelength range is an arithmetic average of reflectances at every 1 nm in the wavelength range.

In the disclosure, an optical property refers to a value measured using an ultraviolet-visible spectrophotometer.

In the disclosure, the angle of incidence refers to an angle formed by a straight line (normal line) perpendicular to a surface of a measurement target and incident light.

### <Optical Filter>

An optical filter of the disclosure includes a first dielectric multilayer film, an ytterbium-containing glass substrate (hereinafter, may be referred to as a Yb glass substrate), and a second dielectric multilayer film in this order.

Due to reflection characteristics of the dielectric multilayer films and absorption characteristics of the Yb glass substrate, it is possible to realize the optical filter of the disclosure in which the transmissivity of visible light and near-infrared light in the vicinity of 850 nm is excellent, the blocking performance of near-infrared light in the vicinity of 940 nm is excellent, and the shift amount of the spectral curve is small even at a high angle of incidence.

Hereinafter, a configuration of the optical filter of the disclosure will be described with reference to the drawings.

Note that sizes of members in each drawing are conceptual, and a relative relationship between the sizes of the members is not limited thereto. In addition, members having substantially the same functions are denoted by the same reference numerals throughout all drawings, and redundant description may be omitted.

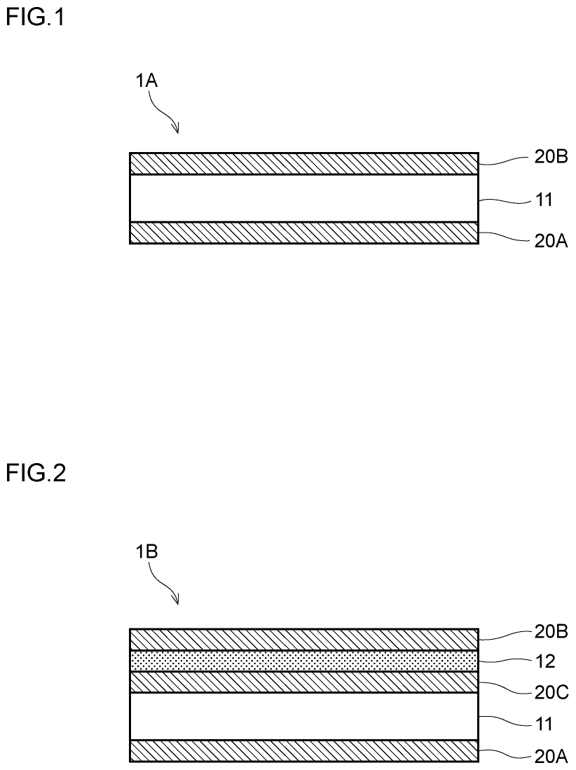

The optical filter 1A illustrated in FIG. 1 includes a dielectric multilayer film 20A as a first dielectric multilayer film, a Yb glass substrate 11, and a dielectric multilayer film 20B as a second dielectric multilayer film in this order. The dielectric multilayer film 20A and the dielectric multilayer film 20B are provided as outermost layers on one principal surface side and the other principal surface side of the Yb glass substrate 11. The optical filter 1A may further include a resin layer between the Yb glass substrate 11 and the dielectric multilayer film 20B.

The optical filter 1B illustrated in FIG. 2 includes a dielectric multilayer film 20A as a first dielectric multilayer film, a Yb glass substrate 11, a dielectric multilayer film 20C as a third dielectric multilayer film, a resin layer 12, and a dielectric multilayer film 20B as a second dielectric multilayer film in this order. The dielectric multilayer film 20A and the dielectric multilayer film 20B are provided as outermost layers on one principal surface side and the other principal surface side of the Yb glass substrate 11.

The optical filter of the disclosure satisfies the following spectral characteristics (I-i) to (I-v).
(I-i) An average transmittance T[450-800(0deg)AVE] at wavelengths of from 450 to 800 nm in a spectral transmittance curve at an angle of incidence of 0 degrees is 90% or more.
(I-ii) A maximum transmittance T[830-860(0deg)MAX] at wavelengths of from 830 to 860 nm in a spectral transmittance curve at an angle of incidence of 0 degrees is 80% or more.
(I-iii) A maximum transmittance T[830-860 (35deg)MAX] at wavelengths of from 830 to 860 nm in a spectral transmittance curve at an angle of incidence of 35 degrees is 80% or more.
(I-iv) A minimum transmittance T[930-960(0deg)MIN] at wavelengths of from 930 to 960 nm in a spectral transmittance curve at an angle of incidence of 0 degrees is 0.2% or less.
(I-v) A minimum transmittance T[930-960 (35deg)MIN] at wavelengths of from 930 to 960 nm in a spectral transmittance curve at an angle of incidence of 35 degrees is 0.2% or less.

The optical filter of the disclosure that satisfies the spectral characteristics (I-i) to (I-v) is an optical filter that is excellent in transmissivity of visible light as shown in the characteristic (I-i), is excellent in transmissivity of infrared light in the vicinity of 850 nm regardless of the magnitude of the angle of incidence as shown in the characteristics (I-ii) and (I-iii), and is excellent in blocking performance of near-infrared light in the vicinity of 940 nm regardless of the magnitude of the angle of incidence as shown in the characteristics (I-iv) and (I-v).

Satisfying the spectral characteristic (I-i) means excellent transmissivity in the visible light region and the near-infrared region of from 450 to 800 nm.

T[450-800(0deg)AVE] is preferably 92% or more, more preferably 93% or more, and still more preferably 95% or more. T[450-800(0deg)AVE] may be 100% or less.

In order to satisfy the spectral characteristic (I-i), for example, a dielectric multilayer film and a Yb glass substrate excellent in transmissivity in a visible light region may be used.

Satisfying the spectral characteristic (I-ii) means excellent transmissivity in a near-infrared light region of from 830 to 860 nm at an angle of incidence of 0 degrees.

T[830-860(0deg)MAX] is preferably 83% or more, more preferably 86% or more, and still more preferably 90% or more. T[830-860(0deg)MAX] may be 100% or less.

In order to satisfy the spectral characteristic (I-ii), for example, a dielectric multilayer film having excellent transmissivity in a near-infrared light region of from 830 to 860 nm may be used.

Satisfying the spectral characteristic (I-iii) means excellent transmissivity in a near-infrared light region of from 830 to 860 nm at an angle of incidence of 35 degrees.

T[830-860 (35deg)MAX] is preferably 82% or more, more preferably 84% or more, and still more preferably 87% or more. T[830-860 (35deg)MAX] may be 100% or less.

In order to satisfy the spectral characteristic (I-iii), for example, a dielectric multilayer film having excellent transmissivity in a near-infrared light region of from 830 to 860 nm may be used.

Satisfying the spectral characteristic (I-iv) means excellent blocking performance in a near-infrared light region of from 930 to 960 nm at an angle of incidence of 0 degrees.

T[930-960(0deg)MIN] is preferably 0.1% or less. T[930-960(0deg)MIN] may be 0% or more.

In order to satisfy the spectral characteristic (I-iv), for example, a dielectric multilayer film having excellent blocking performance in a near-infrared light region of from 930 to 960 nm may be used.

Satisfying the spectral characteristic (I-v) means excellent blocking performance in a near-infrared light region of from 930 to 960 nm at an angle of incidence of 35 degrees.

T[930-960 (35deg)MIN] is preferably 0.1% or less. T[930-960 (35deg)MIN] may be 0% or more.

In order to satisfy the spectral characteristic (I-v), for example, a dielectric multilayer film having excellent blocking performance in a near-infrared light region of from 930 to 960 nm may be used.

In the optical filter of the disclosure, in a case in which at least one of the first dielectric multilayer film side or the second dielectric multilayer film side is the direction of incidence side, in a spectral reflectance curve at an angle of incidence of 5 degrees, an average reflectance RI[930-960(5deg)AVE] at wavelengths of from 930 to 960 nm is 60% or more, preferably 65% or more, and more preferably 80% or more. RI[930-960(5deg)AVE] may be 100% or less.

In the optical filter of the disclosure, it is sufficient that RI[930-960(5deg)AVE] is 60% or more in a case in which at least one of the first dielectric multilayer film side or the second dielectric multilayer film side is the direction of incidence side, RI[930-960(5deg)AVE] may be 60% or more in a case in which the first dielectric multilayer film side is the direction of incidence side, RI[930-960(5deg)AVE] may be 60% or more in a case in which the second dielectric multilayer film side is the direction of incidence side, and

RI[930-960(5deg)AVE] is preferably 60% or more in a case in which at least a dielectric multilayer film side configured as a reflective film that reflects near-infrared light to be described later is the direction of incidence side.

In order to set RI[930-960(5deg)AVE] to 60% or more in a case in which at least one of the first dielectric multilayer film side or the second dielectric multilayer film side is the direction of incidence side, for example, a dielectric multilayer film having excellent reflection characteristics in a near-infrared light region of from 930 to 960 nm may be used.

The optical filter of the disclosure preferably satisfies the following spectral characteristics (I-vi) and (I-vii).
(I-vi) In a spectral transmittance curve at an angle of incidence of 0 degrees, the wavelength IR50_{L} (0deg) at which the transmittance is 50% is in the range of from 860 to 900 nm.
(I-vii) In a spectral transmittance curve at an angle of incidence of 35 degrees, the wavelength IR50_{L} (35deg) at which the transmittance is 50% is in the range of from 850 to 900 nm.

Satisfying the spectral characteristic (I-vi) means that the transmittance is high in a wide range from the visible wavelength range to the near-infrared wavelength range.

IR50_{L} (0deg) is preferably in the range of from 865 to 895 nm, more preferably in the range of from 870 to 890 nm, and still more preferably in the range of from 870 to 880 nm.

In order to satisfy the spectral characteristic (I-vi), for example, a method of using a substrate having a high transmittance of light in the visible wavelength range to the near-infrared wavelength range or using a dielectric multilayer film having a low reflection of light in the visible wavelength range to the near-infrared wavelength range may be adopted.

Satisfying the spectral characteristic (I-vii) means that the transmittance is high in a wide range from the visible wavelength range to the near-infrared wavelength range.

IR50_{L} (35deg) is preferably in the range of from 855 to 895 nm, more preferably in the range of from 855 to 890 nm, and still more preferably in the range of from 855 to 880 nm.

In order to satisfy the spectral characteristic (I-vii), for example, a method of using a substrate having a high transmittance of light in the visible wavelength range to the near-infrared wavelength range or using a dielectric multilayer film having a low reflection of light in the visible wavelength range to the near-infrared wavelength range may be adopted.

In the optical filter of the disclosure, an absolute value of the difference between IR50_{L} (0deg) and IR50_{L} (35deg) is preferably 20 nm or less, more preferably 17.5 nm or less, and still more preferably 15 nm or less, from the viewpoint that the smaller the absolute value, the higher the performance as a product. The absolute value of the difference between IR50_{L} (0deg) and IR50_{L} (35deg) may be 0 nm or more.

In order to set the absolute value of the difference between IR50_{L} (0deg) and IR50_{L} (35deg) to 15 nm or less, for example, a method of providing a resin layer containing a dye having absorption at both wavelengths of IR50_{L} (0deg) and IR50_{L} (35deg) may be adopted.

An absolute value of the difference between T[830-860(0deg)MAX] and T[830-860 (35deg)MAX] is preferably 10% or less, more preferably 9% or less, and still more preferably 8% or less, from the viewpoint of reducing signal noise. The absolute value of the difference between T[830-860(0deg)MAX] and T[830-860 (35deg)MAX] may be 0% or more.

In order to set the absolute value of the difference between T[830-860(0deg)MAX] and T[830-860 (35deg)MAX] to 10% or less, for example, a method of suppressing the reflectance at wavelengths of from 830 to 860 nm in the dielectric multilayer film may be adopted.

An absolute value of the difference between the minimum optical density OD[930-960(0deg)] at wavelengths of from 930 to 960 nm at an angle of incidence of 0 degrees and the minimum optical density OD[930-960 (35deg)] at wavelengths of from 930 to 960 nm at an angle of incidence of 35 degrees is preferably 1.00 or less, more preferably 0.95 or less, and still more preferably 0.90 or less, from the viewpoint of reducing signal noise. The absolute value of the difference between OD[930-960(0deg)] and OD[930-960 (35deg)] may be 0.00 or more.

In order to set the absolute value of the difference between OD[930-960(0deg)] and OD[930-960 (35deg)] to 1.00 or less, for example, a method of using a substrate having absorption at wavelengths of from 930 to 960 nm may be adopted.

OD[930-960(0deg)] is preferably 2.80 or more, more preferably 2.90 or more, and still more preferably 3.00 or more, from the viewpoint of reducing signal noise. OD[930-960(0deg)] may be 6.00 or less.

In order to set the OD[930-960(0deg)] to 2.80 or more, for example, a method of increasing the reflectance at wavelengths of from 930 to 960 nm in the dielectric multilayer film may be adopted.

OD[930-960 (35deg)] is preferably 3.70 or more, more preferably 3.90 or more, and still more preferably 4.10 or more, from the viewpoint of reducing signal noise. OD[930-960 (35deg)] may be 6.00 or less.

In order to set the OD[930-960 (35deg)] to 3.70 or more, for example, a method of increasing the reflectance of light having wavelengths of from 930 to 960 nm using an antireflective film may be adopted.

In the disclosure, the optical density OD is a value calculated by OD=−log(T/100) using a transmittance T (%). A minimum optical density in a specific wavelength range is a minimum value of optical densities at every 1 nm in the wavelength range.

The optical filter of the disclosure includes the Yb glass substrate. The Yb glass substrate preferably has a maximum absorption wavelength in a wavelength range of from 900 to 1000 nm. In a case in which the Yb glass substrate has a maximum absorption wavelength in the wavelength range of from 900 to 1000 nm, it is possible to compensate for the light blocking performance in a region that is not blocked by the reflection characteristics of the dielectric multilayer film.

The Yb glass substrate is excellent in transmissivity in a visible light region and transmissivity from visible light to a near-infrared light region of about 800 nm, and particularly absorbs near-infrared light of from 900 to 1000 nm. Since light is blocked by absorption characteristics, the influence of the angle of incidence on the light blocking performance is small unlike the dielectric multilayer film. Therefore, by using the Yb glass substrate, in particular, in a case in which a sensing wavelength range is from 800 to 900 nm, it is possible to obtain an optical filter which is excellent in transmissivity in a near-infrared light region even at a high angle of incidence, in which a spectral transmittance curve of a boundary region between the transmission region and a wavelength range after 900 nm to be blocked is less likely to shift by the angle of incidence, and which is not easily affected by the angle of incidence.

Respective components that can configure the Yb glass substrate used in the disclosure and suitable contents thereof (in terms of mol % on an oxide basis) will be described below. In the disclosure, unless otherwise specified, the content of each component and a total content are expressed in terms of mol % on an oxide basis.

Yb₂O₃ is an essential component for efficiently absorbing light having wavelengths of around from 900 to 1000 nm, particularly light having a wavelength of 940 nm, and lowering transmittance. In a case in which the content of Yb₂O₃ in the Yb glass substrate is 20 mol % or more, the effect can be sufficiently obtained, and in a case in which the content is 60 mol % or less, problems such as a deterioration of the devitrification resistance of glass, deterioration of meltability, and generation of stray light due to fluorescence are less likely to occur.

Therefore, the content of Yb₂O₃ is preferably from 20 to 60 mol %, more preferably from 25 to 60 mol %, still more preferably from 30 to 60 mol %, still further preferably from 35 to 60 mol %, particularly preferably more than 40 mol % and 60 mol % or less, and most preferably from 45 to 60 mol %.

SiO₂ is a main component that forms glass, and is a component for increasing the devitrification resistance of glass and the viscosity with respect to a liquid phase temperature. In a case in which the content of SiO₂ in the Yb glass substrate is 0.1 mol % or more, problems such as instability of glass, deterioration of weather resistance, and generation of striae in glass are less likely to occur.

In a case in which the content of SiO₂ is 50 mol % or less, a problem such as deterioration of meltability of glass is less likely to occur.

Therefore, the content of SiO₂ is preferably from 0.1 to 50 mol %, more preferably from 0.1 to 40 mol %, still more preferably from 0.1 to 30 mol %, still further preferably from 0.1 to 20 mol %, particularly preferably from 0.1 to 10 mol %, and most preferably from 0.1 to 3 mol % (but excluding 3 mol %).

B₂O₃ is a main component that forms glass, and is a component for increasing the devitrification resistance of glass and the viscosity with respect to a liquid phase temperature. In a case in which the content of B₂O₃ is 15 mol % or more in the Yb glass substrate, a problem such as instability of glass is less likely to occur. In a case in which the content of B₂O₃ is 40 mol % or less, problems such as a decrease in the weather resistance of glass and generation of striae in glass are less likely to occur.

Therefore, the content of B₂O₃ is preferably from 15 to 40 mol %, more preferably from 15 to 38 mol %, still more preferably from 15 to 36 mol %, still further preferably from 15 to 34 mol %, particularly preferably from 15 to 32 mol %, and most preferably from 15 to 30 mol %.

The Yb glass substrate preferably contains at least one of SiO₂ or B₂O₃, from the viewpoint of obtaining stable glass. A total content of the components is preferably 25 mol % or more from the viewpoint that a problem such as instability of glass is less likely to occur, and is preferably 50 mol % or less from the viewpoint that a problem such as deterioration of meltability of glass is less likely to occur.

Therefore, the total content is more preferably from 26 to 45 mol %, still more preferably from 27 to 40 mol %, still further preferably from 28 to 39 mol %, particularly preferably from 29 to 38 mol %, and most preferably from 30 to 37 mol %. P₂O₅ is a component for improving the meltability and stability of glass. The content of P₂O₅ in the Yb glass substrate is preferably from 0 to 15 mol %. In a case in which the content of P₂O₅ is 15 mol % or less, problems such as deterioration of weather resistance of glass, phase separation of glass, and generation of striae in glass are less likely to occur.

The content of P₂O₅ is more preferably from 1 to 13 mol %, still more preferably from 2 to 12 mol %, still more preferably from 3 to 11 mol %, and most preferably from 4 to 10 mol %.

GeO₂ is a component for increasing devitrification resistance of glass and the viscosity with respect to a liquid phase temperature. The content of GeO₂ in the Yb glass substrate is preferably from 0 to 15 mol %. In a case in which the content of GeO₂ is 15 mol % or less, a problem such as deterioration of meltability of glass is less likely to occur.

The content of GeO₂ is more preferably from 0 to 13 mol %, still more preferably from 0 to 11 mol %, still more preferably from 0 to 9 mol %, and most preferably from 0 to 7 mol %.

Ga₂O₃ is a component for increasing the Young's modulus of glass and improving the meltability and stability. The content of Ga₂O₃ in the Yb glass substrate is preferably from 0 to 30 mol %. In a case in which the content of Ga₂O₃ is 30 mol % or less, problems such as a deterioration of the devitrification resistance of glass, and generation of stray light due to reflected light resulting from an increase in reflectance, are less likely to occur.

The content of Ga₂O₃ is more preferably from 0.5 to 28 mol %, still more preferably from 1 to 26 mol %, still further preferably from 2 to 24 mol %, and most preferably from 3 to 22 mol %.

ZrO₂ is a component for increasing the Young's modulus of glass and increasing the viscosity of glass with respect to a liquid phase temperature. The content of ZrO₂ in the Yb glass substrate is preferably from 0 to 7 mol %. In a case in which the content of ZrO₂ is 7 mol % or less, problems such as a deterioration of the devitrification resistance of glass and deterioration of meltability are less likely to occur.

The content of ZrO₂ is more preferably from 0 to 6 mol %, still more preferably from 0 to 5 mol %, still further preferably from 0 to 4 mol %, and most preferably from 0 to 3 mol %.

La₂O₃ is a component for increasing the Young's modulus of glass and improving meltability. The content of La₂O₃ in the Yb glass substrate is preferably from 0.1 to 20 mol %. In a case in which the content of La₂O₃ is 0.1 mol % or more, the effect can be sufficiently obtained, and in a case in which the content of La₂O₃ is 20 mol % or less, problems such as a deterioration of the devitrification resistance of glass, and generation of stray light due to reflected light resulting from an increase in reflectance, are less likely to occur.

The content of La₂O₃ is more preferably from 0.5 to 19 mol %, still more preferably 1 to 18 mol %, still further preferably from 2 to 17 mol %, and most preferably from 2 to 16 mol %.

Al₂O₃ is a component for increasing the Young's modulus of glass and decreasing a refractive index of glass. The content of Al₂O₃ in the Yb glass substrate is preferably from 0.1 to 20 mol %. In a case in which the content of Al₂O₃ is 0.1 mol % or more, the effect can be sufficiently obtained, and in a case in which the content of Al₂O₃ is 20 mol % or less, problems such as a deterioration of the devitrification resistance of glass, and generation of stray light due to reflected light resulting from an increase in reflectance, are less likely to occur.

The content is more preferably from 0.1 to 18 mol %, still more preferably from 0.1 to 15 mol %, still further preferably from 0.1 to 13 mol %, and most preferably from 0.1 to 11 mol %.

A ratio of a total amount of the Al₂O₃, GeO₂, Ga₂O₃, and P₂O₅ components to a total content of the SiO₂ and B₂O₃ components, that is, (total content of Al₂O₃, GeO₂, Ga₂O₃, and P₂O₅)/(total content of SiO₂ and B₂O₃) is preferably from 0.3 to 0.6, from the viewpoint of vitrifying the Yb glass substrate without causing devitrification.

The Yb glass substrate may further contain an alkali metal oxide, an alkaline earth metal oxide, Sb₂O₃, Cl, F, and other components as long as the object of the disclosure is not impaired.

A thickness of the Yb glass substrate is preferably 1.0 mm or less, and more preferably 0.8 mm or less, from the viewpoint of reducing a thickness of the optical filter. The thickness of the Yb glass substrate is preferably 0.4 mm or more, and more preferably 0.5 mm or more, from the viewpoint of strength of the optical filter. The thickness of the Yb glass substrate is preferably from 0.4 to 1.0 mm.

The optical filter of the disclosure may include a resin layer (hereinafter, may be referred to as a “specific resin layer” or simply as a “resin film”) containing a dye having a maximum absorption wavelength of from 370 to 440 nm between the Yb glass substrate and the second dielectric multilayer film in order to compensate for the light blocking performance in a specific wavelength range.

In a case in which the optical filter includes the specific resin layer, the specific resin layer may be provided in contact with the Yb glass substrate, or may be provided on the Yb glass substrate via another layer such as a dielectric multilayer film.

In the optical filter of the disclosure including the specific resin layer, a wavelength IR50ₛ(0deg) at which transmittance is 50% falls within a range of from 390 to 440 nm in a spectral transmittance curve at an angle of incidence of 0 degrees, a wavelength IR50ₛ(35deg) at which transmittance is 50% falls within a range of from 390 to 440 nm in a spectral transmittance curve at an angle of incidence of 35 degrees, and an absolute value of the difference between IR50ₛ(0deg) and IR50ₛ(35deg) is preferably 2 nm or less, from the viewpoint that a large amount of light in a visible wavelength range can be captured and spectral characteristics do not change even in a case in which the angle of incidence of light changes.

The absolute value of the difference between IR50ₛ(0deg) and IR50ₛ(35deg) is preferably 1.5 nm or less, and more preferably 1 nm or less. The absolute value of the difference between IR50ₛ(0deg) and IR50ₛ(35deg) may be 0 nm or more.

In order to set the absolute value of the difference between IR50ₛ(0deg) and IR50ₛ(35deg) to 2 nm or less, for example, a method of providing a resin layer containing a dye and increasing the amount of the dye added that absorbs near ultraviolet light to increase the amount of absorption of near ultraviolet light may be adopted.

The IR50ₛ(0deg) in the range of from 390 to 440 nm means that light of 440 nm or more is transmitted.

IR50ₛ(0deg) is preferably in the range of from 395 to 435 nm, more preferably in the range of from 400 to 430 nm, and still more preferably in the range of from 405 to 425 nm.

In order to set the IR50ₛ(0deg) to the range of from 390 to 440 nm, for example, a method of providing a resin layer containing a dye having a maximum absorption wavelength on a shorter wavelength side than 390 nm may be adopted.

The IR50ₛ(35deg) in the range of from 390 to 440 nm means that light of 440 nm or more is transmitted.

The IR50ₛ(35deg) is preferably in the range of from 395 to 435 nm, more preferably in the range of from 400 to 430 nm, and still more preferably in the range of from 405 to 425 nm.

In order to set the IR50ₛ(35deg) to the range of from 390 to 440 nm, for example, a method of providing a resin layer containing a dye having a maximum absorption wavelength on the shorter wavelength side than 390 nm may be adopted.

The dye having a maximum absorption wavelength of from 370 to 440 nm contained in the resin film may be selected from, for example, a merocyanine dye, an azomethine dye, or a benzotriazole dye. The dyes contained in the resin film may be used singly or in combination of two or more kinds thereof.

A resin forming the resin film is not particularly limited as long as the resin is transparent. The resin may be selected from, for example, a polyester resin, an acrylic resin, an epoxy resin, an ene-thiol resin, a polycarbonate resin, a polyether resin, a polyarylate resin, a polysulfone resin, a polyethersulfone resin, a polyparaphenylene resin, a polyarylene etherphosphine oxide resin, a polyamide resin, a polyimide resin, a polyamideimide resin, a polyolefin resin, a cyclic olefin resin, a polyurethane resin, a polystyrene resin, and the like.

The resin is preferably selected from a polyimide resin, a polycarbonate resin, a polyester resin, or an acrylic resin, from the viewpoint of spectral characteristics, a glass transition point (Tg), and adhesion of a resin film.

The glass transition point (Tg) of the resin is preferably 200° C. or higher from the viewpoint of heat resistance.

The resins contained in the resin film may be used singly or in combination of two or more kinds thereof.

A method of forming the resin film is not particularly limited.

The resin film can be formed by dissolving or dispersing a dye, a resin or a raw material component of a resin, and respective components incorporated as necessary, in a solvent to prepare a coating liquid, coating a support with the coating liquid, and drying the coating liquid to obtain a film, and further curing the film as necessary.

In this case, a support may be a Yb glass substrate configuring an optical filter, or may be a peelable support used only when forming a resin film. The solvent may be any dispersion medium or solvent that can stably disperse or dissolve the dye and the resin or the raw material component of the resin.

The coating liquid may contain a surfactant for improving voids due to minute bubbles, dents due to adhesion of foreign matters and the like, repellency in the drying step, and the like. For the coating with the coating liquid, for example, an immersion coating method, a cast coating method, or a spin coating method can be used. The coating liquid is applied onto a support and then dried to form a resin film. In a case in which the coating liquid contains a raw material component of a transparent resin, a curing treatment such as thermal curing or photocuring is further performed.

The resin film can also be produced into a film shape by extrusion molding. The obtained film-shaped resin film can be laminated on a Yb glass substrate and integrated by thermocompression bonding or the like.

A thickness of the resin film is preferably 10 μm or less, more preferably 5 μm or less, from the viewpoints of in-plane film thickness distribution in a substrate after coating and appearance quality, and is preferably 0.5 μm or more from the viewpoint of exhibiting desired spectral characteristics at an appropriate dye concentration. In a case in which the optical filter has two or more resin film layers, a total thickness of respective resin films is preferably within the above range.

The optical filter of the disclosure includes the first dielectric multilayer film and the second dielectric multilayer film. At least one of the first dielectric multilayer film or the second dielectric multilayer film is preferably designed as a reflective film (hereinafter, also referred to as an “NIR reflective film”) that reflects near-infrared light. In a case in which a resin film is provided between the second dielectric multilayer film and the glass substrate, it is preferable that the first dielectric multilayer film is designed as the NIR reflective film from the viewpoint that the film thickness difference between the front and back of the glass substrate is small and the amount of warpage as a product is small.

In a certain aspect, the first dielectric multilayer film may be configured as the NIR reflective film, and the second dielectric multilayer film may be configured as an antireflective film.

The dielectric multilayer film may be configured of a repeated laminated film including a high refractive index film H and a low refractive index film L (made of a constituent material having a refractive index at a wavelength of 500 nm smaller than that of a constituent material of the high refractive index film H), or a repeated laminated film including a high refractive index film H, an intermediate refractive index film M (made of a constituent material having a refractive index at a wavelength of 500 nm smaller than that of a constituent material of the high refractive index film H), and a low refractive index film L′ (made of a constituent material having a refractive index at a wavelength of 500 nm smaller than that of a constituent material of the intermediate refractive index film M).

In the disclosure, the refractive index means a refractive index for light having a wavelength of 500 nm.

In the disclosure, examples of the “dielectric” include organic substances such as plastics and ceramics such as metal oxides. Whether or not the optical filter of the disclosure includes a dielectric multilayer film can be confirmed by a standard method such as X-ray analysis.

The constituent material of the high refractive index film preferably has, for example, a refractive index of 2.0 or more, and more preferably from 2.2 to 2.7. Examples of such a constituent material include TiO₂, Nb₂O₅ (refractive index: 2.38), Ta₂O₅, or a composite oxide thereof.

The constituent material of the intermediate refractive index film preferably has, for example, a refractive index of from more than 1.6 to less than 2.0, and more preferably from 1.62 to 1.92. Examples of such constituent materials include Al₂O₃, Y₂O₃ (refractive index: 1.81), a composite oxide thereof, and a mixture film of Al₂O₃ and ZrO₂ (refractive index: 1.67). In addition, the intermediate refractive index film may be substituted by an equivalent film obtained by combining a high refractive index film and a low refractive index film. Although a refractive index falls outside the above refractive index range, the infrared reflection layer can be configured by treating Ta₂O₅ having a refractive index of around 2.18 as an intermediate refractive index film, only in a case in which TiO₂ or the like having a refractive index of 2.3 or more is used as the high refractive index film.

This configuration has few advantages in optical design; however, the configuration has excellent physical durability and thermal stability, and may be selected depending on the case.

The constituent material of the low refractive index film preferably has, for example, a refractive index of 1.6 or less, and more preferably from 1.36 to 1.50. Examples of such a constituent material include SiO₂, MgF₂, and composite oxides thereof.

The high refractive index film, the intermediate refractive index film, and the low refractive index film may contain an additive for adjusting a refractive index. Examples of additives include SiO₂, Al₂O₃, CeO₂, FeO₂, HfO₂, In₂O₃, MgF₂, Nb₂O₅, SnO₂, Ta₂O₅, TiO₂, Y₂O₃, ZnO, ZrO₂, NiO, indium tin oxide (ITO), antimony doped tin oxide (ATO), and MgO.

A total number of layers of the high refractive index film and the low refractive index film configuring the dielectric multilayer film and a total number of layers of the high refractive index film, the intermediate refractive index film, and the low refractive index film configuring the dielectric multilayer film are preferably 50 or less. In this manner, the productivity of the optical filter can be increased. The number of layers is more preferably 49 or less, and particularly preferably from 15 to 48.

A total layer thickness of the high refractive index film and the low refractive index film configuring the dielectric multilayer film and a total layer thickness of the high refractive index film, the intermediate refractive index film, and the low refractive index film configuring the dielectric multilayer film are preferably 6.0 μm or less. In this manner, in a case in which the dielectric multilayer film is provided on one surface of the Yb glass substrate, it is possible to suppress the warpage of the optical filter due to the internal stress of the dielectric multilayer film. The total layer thickness is more preferably 5.5 μm or less, and particularly preferably from 2.0 to 3.8 μm.

In addition, by providing the dielectric multilayer film divided on one surface and the other surface of the Yb glass substrate, respectively, the internal stress of the dielectric multilayer film on the one surface and the other surface of the Yb glass substrate is mutually offset, and it is possible to suppress the warpage of the optical filter.

The high refractive index film and the low refractive index film configuring the dielectric multilayer film, and the high refractive index film, the intermediate refractive index film, and the low refractive index film configuring the dielectric multilayer film can be formed by a sputtering method, a vacuum vapor deposition method, an ion beam method, an ion plating method, or a CVD method, and are particularly preferably formed by a sputtering method, a vacuum vapor deposition method, or an ion beam method. The dielectric multilayer film forms a wavelength band used for light reception by a solid-state imaging element, and high accuracy is required for reflection conditions in each wavelength band. In order to realize this, the film thickness accuracies of the high refractive index film and the low refractive index film, and the high refractive index film, the intermediate refractive index film, and the low refractive index film are important. A sputtering method, a vacuum vapor deposition method, an ion beam method, and the like are excellent in film thickness control when forming a thin film, and are therefore preferable.

On the Yb glass substrate, in addition to the dielectric multilayer film, a single-layer film or a multilayer film having MgF₂, a composite oxide of alumina and zirconium oxide, or lanthanum titanate (La₂Ti₂O₇) may be provided as an adhesion enhancing layer in order to improve adhesion between the Yb glass substrate and the dielectric multilayer film.

In order to impart conductivity to the optical filter, an antistatic layer made of a thin film of ITO or the like may be provided on the surface side (air side) of the dielectric multilayer film.

In order to make it difficult for foreign matter such as dust to adhere to the optical filter, a foreign matter adhesion suppressing layer made of a thin film containing, for example, a fluorine component may be provided on the surface side (air side) of the dielectric multilayer film.

In the disclosure, the high refractive index film H refers to a QWOT (Quarter-wave Optical Thickness, ¼ wavelength optical film thickness film) at a wavelength of 500 nm made of a high refractive index material. The intermediate refractive index film M refers to a QWOT at a wavelength of 500 nm made of an intermediate refractive index material. The low refractive index film L and the low refractive index film L′ refer to QWOT at a wavelength of 500 nm made of a low refractive index material.

The dielectric multilayer film preferably includes a repeated laminated film having a film configuration represented by the following Formula (6) or (7).

a₁(HL)\hat{ }ⁿ¹a₂(HL)\hat{ }ⁿ²a₃(HL)\hat{ }ⁿ³. . . aₘ(HL)\hat{ }^{nm} (6)

a₁(HML′)\hat{ }ⁿ¹a₂(HML′)\hat{ }ⁿ²a₃(HML′)\hat{ }ⁿ³. . . aₘ(HML′)\hat{ }^{nm}(7)

In Formula (6) or (7), in “(HL)\hat{ }ⁿ”, H means a high refractive index film, L means a low refractive index film, n means a natural number of 2 or more, and \hat{ }ⁿ means a configuration in which (HL) is repeated n times, and in “(HML′)\hat{ }ⁿ”, H means a high refractive index film, M means an intermediate refractive index film, L′ means a low refractive index film, n means a natural number of 2 or more, and \hat{ }ⁿ means a configuration in which (HML′) is repeated n times.

In Formula (6) or (7), n1 to nm, and m are natural numbers of 2 or more, and at least one ratio between any different ones of a₁ to aₘ is 1.04 or more.

A plurality of repeated laminated films represented by a₁(HL)\hat{ }ⁿ¹a₂(HL)\hat{ }ⁿ²a₃(HL)\hat{ }ⁿ³ . . . aₘ(HL)\hat{ }^{nm} or a₁(HML′)\hat{ }ⁿ¹a₂(HML′)\hat{ }ⁿ²a₃(HML′)\hat{ }ⁿ³. aₘ(HML′)\hat{ }^{nm} need to include at least one in which the ratio between any different ones of a₁ to aₘ is 1.04 or more. This is because by shifting the ratio between any different ones of a₁ to aₘ, it is possible to shift the wavelength at which a decrease in light transmittance due to each of the repeated laminated films appears. As a result, it is possible to obtain an effect of suppressing a decrease in light transmittance in a visible wavelength range.

The ratio between any different ones of a₁ to aₘ means that in a case in which m=2, either a₁/a₂ or a₂/a₁ is 1.04 or more. In a case in which m is 3 or more, the ratio between any different ones of a₁ to aₘ means that at least one ratio of combinations of a₁ to aₘ is 1.04 or more.

An example of an aspect of the dielectric multilayer film configuring the optical filter of the disclosure includes a configuration in which, in a case in which a film configuration of the repeated laminated film is (HML)\hat{ }ⁿ, H is a high refractive index film having a film thickness of 70 nm or more, L is a low refractive index film having a film thickness of 100 nm or more, and M is an equivalent film having an intermediate refractive index and consisting of two layers (one H layer and one L layer) each having a film thickness of from 5 to 50 nm.

In addition, an example of another aspect of the dielectric multilayer film configuring the optical filter of the disclosure includes a configuration in which, in a case in which the film configuration of the repeated laminated film is (HMLM)\hat{ }ⁿ, H is a high refractive index film having a film thickness of from 70 to 130 nm and an average in a range of from 80 to 100 nm, L is a low refractive index film having a film thickness of from 120 to 170 nm and an average in a range of from 140 to 170 nm, M is an equivalent film having an intermediate refractive index and consisting of two layers (one H layer and one L layer) each having a film thickness in a range of from 5 to 40 nm, a total thickness of the two layers being from 15 to 50 nm and an average total thickness of the two layers being in a range of from 20 to 40 nm.

The optical filter of the disclosure may include, as other components, for example, a component (layer) that provides absorption by inorganic fine particles or the like that control transmission and absorption of light in a specific wavelength range. Specific examples of the inorganic fine particles include indium tin oxides (ITO), antimony-doped tin oxides (ATO), cesium tungstate, and lanthanum boride. ITO fine particles and cesium tungstate fine particles have high transmittance of visible light and have light absorptivity over a wide infrared wavelength range exceeding 1200 nm, and thus can be used in a case in which such blocking performance for infrared light is required.

### <Imaging Device>

An imaging device of the disclosure includes the optical filter of the disclosure. The imaging device preferably further includes a solid-state imaging element and an imaging lens. By including the optical filter of the disclosure having excellent transmissivity of visible light and specific near-infrared light and blocking performance of specific near-infrared light, an imaging device having excellent color reproducibility even for light at a high angle of incidence can be obtained.

The optical filter of the disclosure can also be used in combination with a band pass filter that transmits visible light and specific near-infrared light. In this case, the imaging device of the disclosure preferably includes the optical filter of the disclosure and a band pass filter having a visible light transmission band including a wavelength range of from 450 nm to 650 nm and a near-infrared light transmission band including a wavelength range of from 840 to 850 nm.

For example, by combining the band pass filter having low angle-of-incidence dependence in a visible light transmission band and low angle-of-incidence dependence at the cutoff edge switching from transmission to blocking on the short wavelength side of the near-infrared light transmission band around 850 nm in the spectral characteristics of the band pass filter, with the optical filter of the disclosure, it is possible to suppress the angle-of-incidence dependence of both the visible light transmission band and the near-infrared light transmission band around 850 nm. Since the optical filter of the disclosure has a high transmittance in the visible light band and around 850 nm, it is possible to add a function of low angle-of-incidence dependence without greatly impairing the transmission characteristics of the band pass filter. In this case, the optical filter of the disclosure may be mounted between a lens and a sensor in the imaging device together with a band pass filter to be combined, or may be mounted between a plurality of lenses. For example, in a case in which the Yb glass substrate configuring the optical filter of the disclosure exceeds 1 mm in thickness, the optical filter of the disclosure may be mounted on the outermost surface of a camera module, and also can be mounted outside the lens or separately from the camera module, functioning as a cover glass. When the filter is mounted between the lenses or between the sensor and the lens, there are many optical design restrictions. However, in a case in which the filter is mounted on the outermost surface of the camera module or outside the lens as a cover glass, the degree of freedom in design can be increased.

### EXAMPLES

Examples of the disclosure will be described below.

Experimental Examples 1 to 4 and 9 are comparative examples, and Experimental Examples 5 to 8 are examples.

Each spectral characteristic was measured using an ultraviolet-visible spectrophotometer (Model UH-4150, manufactured by Hitachi High-Technologies Corporation).

The spectral characteristic in a case in which the angle of incidence is not particularly specified is a value measured at an angle of incidence of 0 degrees (in a direction perpendicular to a principal surface of the optical filter).

Dyes used in respective examples are as follows.

Compound 1 (merocyanine compound): Synthesized based on the specification of German Patent Publication No. 10109243. Compound 1 is a near ultraviolet absorbing dye (UV dye).

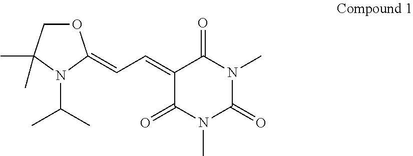 [SMILES: CC(C)N1/C(=C/C=C2C(=O)N(C)C(=O)N(C)C2=O)OCC1(C)C]

The dye (Compound 1) was dissolved in polyimide resin C-3G30G manufactured by MITSUBISHI GAS CHEMICAL COMPANY, INC., and an absorption spectrum thereof was measured. As a result, a maximum absorption wavelength was 400 nm.

With reference to Japanese Patent Application Laid-Open (JP-A) No. S61-163138 and Japanese Patent Application Laid-Open (JP-A) No. S56-78447, a Yb glass substrate 1 (thickness 0.2 mm) and a Yb glass substrate 2 (thickness 0.8 mm) having compositions shown in Table 1 below were produced.

Separately, alkali glass, D263 manufactured by SCHOTT, having a thickness of 0.2 mm was prepared to obtain a glass substrate 3.

TABLE 1

| | mol % |
|---|---|
| SiO₂ | 7.90 |
| B₂O₃ | 25.23 |
| P₂O₅ | 8.02 |
| Al₂O₃ | 9.08 |
| La₂O₃ | 2.55 |
| Yb₂O₃ | 47.22 |
| Total | 100.00 |

### Experimental Example 1

An optical filter of Experimental Example 1 was produced by the following method.

SiO₂ and Al₂O₃ were laminated on one main surface of a Yb glass substrate 1 (thickness: 0.2 mm) by vapor deposition to form a dielectric multilayer film (protective film) having the configuration shown in Table 2. The film No. 1 is on the Yb glass substrate 1 side.

The dye (Compound 1) was dissolved in polyimide resin C-3G30G manufactured by MITSUBISHI GAS CHEMICAL COMPANY, INC., mixed at a concentration shown in Table 3, and stirred and dissolved at 50° C. for 2 hours to obtain a coating liquid. The obtained coating liquid was applied to a surface of the dielectric multilayer film (protective film) by a spin coating method to form a resin layer having a film thickness shown in Table 3.

TABLE 2

| | Membrane | Film Thickness |
|---|---|---|
| No. | Material | [nm] |
| 1 | Al₂O₃ | 38.26 |
| 2 | SiO₂ | 169.28 |

TABLE 3

| | | Resin Layer |
|---|---|---|
| Dye Content | Compound 1 | 6.6 |
| | (IMAX: 400 nm) | |
| (Mass %) | Total | 6.6 |

| | |
|---|---|
| Film Thickness (μm) | 1.0 |

SiO₂ and TiO₂ were laminated on the surface of the resin layer by vapor deposition to form a dielectric multilayer film (antireflection layer) having the configuration shown in Table 4. The film No. 1 is on the resin layer side.

SiO₂ and TiO₂ were laminated on the other main surface of the Yb glass substrate 1 by vapor deposition to form a dielectric multilayer film (reflective film) having the configuration shown in Table 5. The film No. 1 is on the substrate side.

Thus, the optical filter of Experimental Example 1 was produced.

TABLE 4

| | Membrane | Film Thickness |
|---|---|---|
| No. | Material | [nm] |
| 1 | TiO₂ | 9.45 |
| 2 | SiO₂ | 43.99 |
| 3 | TiO₂ | 27.92 |
| 4 | SiO₂ | 18.37 |
| 5 | TiO₂ | 72.90 |
| 6 | SiO₂ | 14.73 |
| 7 | TiO₂ | 26.99 |
| 8 | SiO₂ | 101.35 |

TABLE 5

| | Membrane | Film Thickness |
|---|---|---|
| No. | Material | [nm] |
| 1 | TiO₂ | 16.43 |
| 2 | SiO₂ | 20.56 |
| 3 | TiO₂ | 120.10 |
| 4 | SiO₂ | 30.55 |
| 5 | TiO₂ | 13.15 |
| 6 | SiO₂ | 143.89 |
| 7 | TiO₂ | 12.32 |
| 8 | SiO₂ | 28.88 |
| 9 | TiO₂ | 86.80 |
| 10 | SiO₂ | 16.34 |
| 11 | TiO₂ | 16.23 |
| 12 | SiO₂ | 162.78 |
| 13 | TiO₂ | 11.32 |
| 14 | SiO₂ | 21.02 |
| 15 | TiO₂ | 82.31 |
| 16 | SiO₂ | 14.62 |
| 17 | TiO₂ | 15.37 |
| 18 | SiO₂ | 163.68 |
| 19 | TiO₂ | 11.32 |
| 20 | SiO₂ | 18.19 |
| 21 | TiO₂ | 83.55 |
| 22 | SiO₂ | 15.59 |
| 23 | TiO₂ | 13.18 |
| 24 | SiO₂ | 160.44 |
| 25 | TiO₂ | 11.32 |
| 26 | SiO₂ | 17.71 |
| 27 | TiO₂ | 85.13 |
| 28 | SiO₂ | 17.44 |
| 29 | TiO₂ | 11.80 |
| 30 | SiO₂ | 156.34 |
| 31 | TiO₂ | 11.32 |
| 32 | SiO₂ | 18.51 |
| 33 | TiO₂ | 85.88 |
| 34 | SiO₂ | 18.84 |
| 35 | TiO₂ | 11.68 |
| 36 | SiO₂ | 153.00 |
| 37 | TiO₂ | 11.32 |
| 38 | SiO₂ | 20.79 |
| 39 | TiO₂ | 81.15 |
| 40 | SiO₂ | 14.12 |
| 41 | TiO₂ | 15.79 |
| 42 | SiO₂ | 168.38 |
| 43 | TiO₂ | 11.32 |
| 44 | SiO₂ | 17.62 |
| 45 | TiO₂ | 94.40 |
| 46 | SiO₂ | 88.91 |

### Experimental Example 2

An optical filter of Experimental Example 2 was produced in the same manner as in Experimental Example 1 except that, in the production of the optical filter of Experimental Example 1, a Yb glass substrate 2 (thickness: 0.8 mm) was used instead of the Yb glass substrate 1, and SiO₂ and TiO₂ were laminated on the other main surface of the glass substrate by vapor deposition to form a dielectric multilayer film having the configuration shown in Table 6. The film No. 1 is on the substrate side.

TABLE 6

| | Membrane | Film Thickness |
|---|---|---|
| No. | Material | [nm] |
| 1 | TiO₂ | 16.77 |
| 2 | SiO₂ | 20.98 |
| 3 | TiO₂ | 122.55 |
| 4 | SiO₂ | 31.17 |
| 5 | TiO₂ | 13.42 |
| 6 | SiO₂ | 146.83 |
| 7 | TiO₂ | 12.57 |
| 8 | SiO₂ | 29.47 |
| 9 | TiO₂ | 88.57 |
| 10 | SiO₂ | 16.67 |
| 11 | TiO₂ | 16.56 |
| 12 | SiO₂ | 166.10 |
| 13 | TiO₂ | 11.56 |
| 14 | SiO₂ | 21.45 |
| 15 | TiO₂ | 83.99 |
| 16 | SiO₂ | 14.91 |
| 17 | TiO₂ | 15.69 |
| 18 | SiO₂ | 167.02 |
| 19 | TiO₂ | 11.56 |
| 20 | SiO₂ | 18.56 |
| 21 | TiO₂ | 85.26 |
| 22 | SiO₂ | 15.91 |
| 23 | TiO₂ | 13.45 |
| 24 | SiO₂ | 163.71 |
| 25 | TiO₂ | 11.56 |
| 26 | SiO₂ | 18.07 |
| 27 | TiO₂ | 86.87 |
| 28 | SiO₂ | 17.79 |
| 29 | TiO₂ | 12.04 |
| 30 | SiO₂ | 159.53 |
| 31 | TiO₂ | 11.56 |
| 32 | SiO₂ | 18.88 |
| 33 | TiO₂ | 87.64 |
| 34 | SiO₂ | 19.22 |
| 35 | TiO₂ | 11.92 |
| 36 | SiO₂ | 156.12 |
| 37 | TiO₂ | 11.56 |
| 38 | SiO₂ | 21.22 |
| 39 | TiO₂ | 82.80 |
| 40 | SiO₂ | 14.41 |
| 41 | TiO₂ | 16.11 |
| 42 | SiO₂ | 171.82 |
| 43 | TiO₂ | 11.56 |
| 44 | SiO₂ | 17.98 |
| 45 | TiO₂ | 96.33 |
| 46 | SiO₂ | 90.72 |

### Experimental Example 3

An optical filter of Experimental Example 3 was produced in the same manner as in Experimental Example 2 except that, in the production of the optical filter of Experimental Example 2, the resin layer and the dielectric multilayer film (protective layer) were not provided and the dielectric multilayer film (antireflection layer) was directly formed on one main surface of the Yb glass substrate 2.

### Experimental Example 4

An optical filter of Experimental Example 4 was produced in the same manner as in Experimental Example 1 except that, in the production of the optical filter of Experimental Example 1, a glass substrate 3 (thickness: 0.2 mm) was used instead of the Yb glass substrate 1, and SiO₂ and TiO₂ were laminated on the other main surface of the glass substrate by vapor deposition to form a dielectric multilayer film having the configuration shown in Table 7. The film No. 1 is on the substrate side.

TABLE 7

| | Membrane | Film Thickness |
|---|---|---|
| No. | Material | [nm] |
| 1 | TiO₂ | 15.78 |
| 2 | SiO₂ | 18.01 |
| 3 | TiO₂ | 98.50 |
| 4 | SiO₂ | 24.87 |
| 5 | TiO₂ | 10.54 |
| 6 | SiO₂ | 122.24 |
| 7 | TiO₂ | 10.31 |
| 8 | SiO₂ | 22.71 |
| 9 | TiO₂ | 73.70 |
| 10 | SiO₂ | 15.47 |
| 11 | TiO₂ | 12.32 |
| 12 | SiO₂ | 126.27 |
| 13 | TiO₂ | 7.77 |
| 14 | SiO₂ | 21.59 |
| 15 | TiO₂ | 75.72 |
| 16 | SiO₂ | 14.54 |
| 17 | TiO₂ | 10.18 |
| 18 | SiO₂ | 128.35 |
| 19 | TiO₂ | 7.87 |
| 20 | SiO₂ | 17.96 |
| 21 | TiO₂ | 76.10 |
| 22 | SiO₂ | 15.99 |
| 23 | TiO₂ | 8.51 |
| 24 | SiO₂ | 128.69 |
| 25 | TiO₂ | 8.88 |
| 26 | SiO₂ | 15.22 |
| 27 | TiO₂ | 75.84 |
| 28 | SiO₂ | 18.78 |
| 29 | TiO₂ | 7.42 |
| 30 | SiO₂ | 127.37 |
| 31 | TiO₂ | 10.72 |
| 32 | SiO₂ | 13.55 |
| 33 | TiO₂ | 73.95 |
| 34 | SiO₂ | 21.71 |
| 35 | TiO₂ | 7.38 |
| 36 | SiO₂ | 124.00 |
| 37 | TiO₂ | 12.20 |
| 38 | SiO₂ | 14.03 |
| 39 | TiO₂ | 72.36 |
| 40 | SiO₂ | 24.60 |
| 41 | TiO₂ | 8.34 |
| 42 | SiO₂ | 116.93 |
| 43 | TiO₂ | 12.90 |
| 44 | SiO₂ | 17.77 |
| 45 | TiO₂ | 67.92 |
| 46 | SiO₂ | 21.03 |
| 47 | TiO₂ | 12.19 |
| 48 | SiO₂ | 111.19 |
| 49 | TiO₂ | 9.44 |
| 50 | SiO₂ | 28.32 |
| 51 | TiO₂ | 53.46 |
| 52 | SiO₂ | 7.38 |
| 53 | TiO₂ | 25.86 |
| 54 | SiO₂ | 78.98 |

### Experimental Example 5

An optical filter of Experimental Example 5 was produced in the same manner as in Experimental Example 1 except that, in the production of the optical filter of Experimental Example 1, a Yb glass substrate 2 (thickness: 0.8 mm) was used instead of the Yb glass substrate 1, and SiO₂ and TiO₂ were laminated on the other main surface of the glass substrate by vapor deposition to form a dielectric multilayer film having the configuration shown in Table 8. The film No. 1 is on the substrate side.

TABLE 8

| | Membrane | Film Thickness |
|---|---|---|
| No. | Material | [nm] |
| 1 | TiO₂ | 15.88 |
| 2 | SiO₂ | 19.87 |
| 3 | TiO₂ | 116.05 |
| 4 | SiO₂ | 29.52 |
| 5 | TiO₂ | 12.71 |
| 6 | SiO₂ | 139.05 |
| 7 | TiO₂ | 11.91 |
| 8 | SiO₂ | 27.91 |
| 9 | TiO₂ | 83.87 |
| 10 | SiO₂ | 15.79 |
| 11 | TiO₂ | 15.69 |
| 12 | SiO₂ | 157.30 |
| 13 | TiO₂ | 10.94 |
| 14 | SiO₂ | 20.31 |
| 15 | TiO₂ | 79.54 |
| 16 | SiO₂ | 14.12 |
| 17 | TiO₂ | 14.86 |
| 18 | SiO₂ | 158.17 |
| 19 | TiO₂ | 10.94 |
| 20 | SiO₂ | 17.58 |
| 21 | TiO₂ | 80.74 |
| 22 | SiO₂ | 15.06 |
| 23 | TiO₂ | 12.73 |
| 24 | SiO₂ | 155.04 |
| 25 | TiO₂ | 10.94 |
| 26 | SiO₂ | 17.11 |
| 27 | TiO₂ | 82.26 |
| 28 | SiO₂ | 16.85 |
| 29 | TiO₂ | 11.40 |
| 30 | SiO₂ | 151.07 |
| 31 | TiO₂ | 10.94 |
| 32 | SiO₂ | 17.88 |
| 33 | TiO₂ | 82.99 |
| 34 | SiO₂ | 18.20 |
| 35 | TiO₂ | 11.29 |
| 36 | SiO₂ | 147.85 |
| 37 | TiO₂ | 10.94 |
| 38 | SiO₂ | 20.09 |
| 39 | TiO₂ | 78.41 |
| 40 | SiO₂ | 13.65 |
| 41 | TiO₂ | 15.26 |
| 42 | SiO₂ | 162.71 |
| 43 | TiO₂ | 10.94 |
| 44 | SiO₂ | 17.02 |
| 45 | TiO₂ | 91.22 |
| 46 | SiO₂ | 85.91 |

### Experimental Example 6

An optical filter of Experimental Example 6 was produced in the same manner as in Experimental Example 1 except that, in the production of the optical filter of Experimental Example 1, a Yb glass substrate 2 (thickness: 0.8 mm) was used instead of the Yb glass substrate 1, and SiO₂ and TiO₂ were laminated on the other main surface of the glass substrate by vapor deposition to form a dielectric multilayer film having the configuration shown in Table 9. The film No. 1 is on the substrate side.

TABLE 9

| | Membrane | Film Thickness |
|---|---|---|
| No. | Material | [nm] |
| 1 | TiO₂ | 14.58 |
| 2 | SiO₂ | 25.12 |
| 3 | TiO₂ | 111.45 |
| 4 | SiO₂ | 27.54 |
| 5 | TiO₂ | 10.02 |
| 6 | SiO₂ | 138.40 |
| 7 | TiO₂ | 13.31 |
| 8 | SiO₂ | 16.68 |
| 9 | TiO₂ | 92.66 |
| 10 | SiO₂ | 16.64 |
| 11 | TiO₂ | 12.59 |
| 12 | SiO₂ | 142.59 |
| 13 | TiO₂ | 10.88 |
| 14 | SiO₂ | 18.65 |
| 15 | TiO₂ | 87.68 |
| 16 | SiO₂ | 12.20 |
| 17 | TiO₂ | 10.54 |
| 18 | SiO₂ | 154.79 |
| 19 | TiO₂ | 8.72 |
| 20 | SiO₂ | 12.76 |
| 21 | TiO₂ | 92.07 |
| 22 | SiO₂ | 13.48 |
| 23 | TiO₂ | 9.02 |
| 24 | SiO₂ | 157.77 |
| 25 | TiO₂ | 8.60 |
| 26 | SiO₂ | 9.08 |
| 27 | TiO₂ | 90.87 |
| 28 | SiO₂ | 17.51 |
| 29 | TiO₂ | 8.36 |
| 30 | SiO₂ | 144.09 |
| 31 | TiO₂ | 11.86 |
| 32 | SiO₂ | 15.83 |
| 33 | TiO₂ | 93.05 |
| 34 | SiO₂ | 19.33 |
| 35 | TiO₂ | 8.58 |
| 36 | SiO₂ | 143.84 |
| 37 | TiO₂ | 12.20 |
| 38 | SiO₂ | 14.98 |
| 39 | TiO₂ | 86.22 |
| 40 | SiO₂ | 21.67 |
| 41 | TiO₂ | 12.47 |
| 42 | SiO₂ | 130.85 |
| 43 | TiO₂ | 11.90 |
| 44 | SiO₂ | 27.95 |
| 45 | TiO₂ | 51.77 |
| 46 | SiO₂ | 15.82 |
| 47 | TiO₂ | 28.50 |
| 48 | SiO₂ | 91.42 |

### Experimental Example 7

An optical filter of Experimental Example 7 was produced in the same manner as in Experimental Example 1 except that, in the production of the optical filter of Experimental Example 1, a Yb glass substrate 2 (thickness: 0.8 mm) was used instead of the Yb glass substrate 1, and SiO₂ and TiO₂ were laminated on the other main surface of the glass substrate by vapor deposition to form a dielectric multilayer film having the configuration shown in Table 10. The film No. 1 is on the substrate side.

TABLE 10

| | Membrane | Film Thickness |
|---|---|---|
| No. | Material | [nm] |
| 1 | TiO₂ | 16.24 |
| 2 | SiO₂ | 20.32 |
| 3 | TiO₂ | 118.68 |
| 4 | SiO₂ | 30.19 |
| 5 | TiO₂ | 13.00 |
| 6 | SiO₂ | 142.19 |
| 7 | TiO₂ | 12.18 |
| 8 | SiO₂ | 28.54 |
| 9 | TiO₂ | 85.77 |
| 10 | SiO₂ | 16.14 |
| 11 | TiO₂ | 16.04 |
| 12 | SiO₂ | 160.86 |
| 13 | TiO₂ | 11.19 |
| 14 | SiO₂ | 20.77 |
| 15 | TiO₂ | 81.34 |
| 16 | SiO₂ | 14.44 |
| 17 | TiO₂ | 15.19 |
| 18 | SiO₂ | 161.75 |
| 19 | TiO₂ | 11.19 |
| 20 | SiO₂ | 17.98 |
| 21 | TiO₂ | 82.56 |
| 22 | SiO₂ | 15.40 |
| 23 | TiO₂ | 13.02 |
| 24 | SiO₂ | 158.54 |
| 25 | TiO₂ | 11.19 |
| 26 | SiO₂ | 17.50 |
| 27 | TiO₂ | 84.12 |
| 28 | SiO₂ | 17.23 |
| 29 | TiO₂ | 11.66 |
| 30 | SiO₂ | 154.49 |
| 31 | TiO₂ | 11.19 |
| 32 | SiO₂ | 18.29 |
| 33 | TiO₂ | 84.87 |
| 34 | SiO₂ | 18.61 |
| 35 | TiO₂ | 11.54 |
| 36 | SiO₂ | 151.19 |
| 37 | TiO₂ | 11.19 |
| 38 | SiO₂ | 20.54 |
| 39 | TiO₂ | 80.19 |
| 40 | SiO₂ | 13.96 |
| 41 | TiO₂ | 15.60 |
| 42 | SiO₂ | 166.39 |
| 43 | TiO₂ | 11.19 |
| 44 | SiO₂ | 17.41 |
| 45 | TiO₂ | 93.29 |
| 46 | SiO₂ | 87.86 |

### Experimental Example 8

An optical filter of Experimental Example 8 was produced in the same manner as in Experimental Example 1 except that, in the production of the optical filter of Experimental Example 1, a Yb glass substrate 2 (thickness: 0.8 mm) was used instead of the Yb glass substrate 1, and SiO₂ and TiO₂ were laminated on the other main surface of the glass substrate by vapor deposition to form a dielectric multilayer film having the configuration shown in Table 11. The film No. 1 is on the substrate side.

TABLE 11

| | Membrane | Film Thickness |
|---|---|---|
| No. | Material | [nm] |
| 1 | TiO₂ | 16.00 |
| 2 | SiO₂ | 20.02 |
| 3 | TiO₂ | 116.96 |
| 4 | SiO₂ | 29.75 |
| 5 | TiO₂ | 12.81 |
| 6 | SiO₂ | 140.14 |
| 7 | TiO₂ | 12.00 |
| 8 | SiO₂ | 28.13 |
| 9 | TiO₂ | 84.53 |
| 10 | SiO₂ | 15.91 |
| 11 | TiO₂ | 15.81 |
| 12 | SiO₂ | 158.53 |
| 13 | TiO₂ | 11.03 |
| 14 | SiO₂ | 20.47 |
| 15 | TiO₂ | 80.16 |
| 16 | SiO₂ | 14.23 |
| 17 | TiO₂ | 14.97 |
| 18 | SiO₂ | 159.41 |
| 19 | TiO₂ | 11.03 |
| 20 | SiO₂ | 17.72 |
| 21 | TiO₂ | 81.37 |
| 22 | SiO₂ | 15.18 |
| 23 | TiO₂ | 12.83 |
| 24 | SiO₂ | 156.25 |
| 25 | TiO₂ | 11.03 |
| 26 | SiO₂ | 17.25 |
| 27 | TiO₂ | 82.91 |
| 28 | SiO₂ | 16.98 |
| 29 | TiO₂ | 11.49 |
| 30 | SiO₂ | 152.26 |
| 31 | TiO₂ | 11.03 |
| 32 | SiO₂ | 18.02 |
| 33 | TiO₂ | 83.64 |
| 34 | SiO₂ | 18.34 |
| 35 | TiO₂ | 11.37 |
| 36 | SiO₂ | 149.01 |
| 37 | TiO₂ | 11.03 |
| 38 | SiO₂ | 20.25 |
| 39 | TiO₂ | 79.03 |
| 40 | SiO₂ | 13.76 |
| 41 | TiO₂ | 15.38 |
| 42 | SiO₂ | 163.99 |
| 43 | TiO₂ | 11.03 |
| 44 | SiO₂ | 17.16 |
| 45 | TiO₂ | 91.94 |
| 46 | SiO₂ | 86.59 |

### Experimental Example 9

An optical filter of Experimental Example 9 was produced in the same manner as in Experimental Example 1 except that, in the production of the optical filter of Experimental Example 1, a glass substrate 3 (thickness: 0.2 mm) was used instead of the Yb glass substrate 1.

For each optical filter obtained as described above, spectral transmittance curves and spectral reflectance curves at each angle of incidence were obtained, and T[450-800(0deg)AVE], T[830-860(0deg)MAX], T[930-960(0deg)MIN], T[830-860 (35deg)MAX], T[930-960 (35deg)MIN], an average reflectance RI[930-960(5deg)AVE]FSR at wavelengths of from 930 to 960 nm in a spectral reflectance curve at an angle of incidence of 5 degrees in a case in which the first dielectric multilayer film (reflective film) side was the direction of incidence side, and an average reflectance RI[930-960(5deg)AVE]BSR at wavelengths of from 930 to 960 nm in a spectral reflectance curve at an angle of incidence of 5 degrees in a case in which the second dielectric multilayer film (antireflection layer) side was the direction of incidence side, IR50_{L} (0deg), IR50_{L} (35deg), OD[930-960(0deg)], OD[930-960 (35deg)], an absolute value (|IR50_{L} (0deg)-IR50_{L} (35deg)|) of the difference between IR50_{L} (0deg) and IR50_{L} (35deg), an absolute value (|T[830-860(0deg)MAX]-T [830-860 (35deg)MAX]|) of the difference between T[830-860(0deg)MAX] and T[830-860 (35deg)MAX], an absolute value (|OD[930-960(0deg)]-OD[930-960 (35deg)]|) of the difference between OD[930-960(0deg)] and OD[930-960 (35deg)], IR50ₛ(0deg), IR50ₛ(35deg), and an absolute value (|IR50ₛ(0deg)-IR50ₛ(35deg)|) of the difference between IR50ₛ(0deg) and IR50ₛ(35deg) were determined. The obtained results are shown in Table 12.

The composition (glass composition) and the thickness (glass plate thickness) of a glass plate are also shown in Table 12.

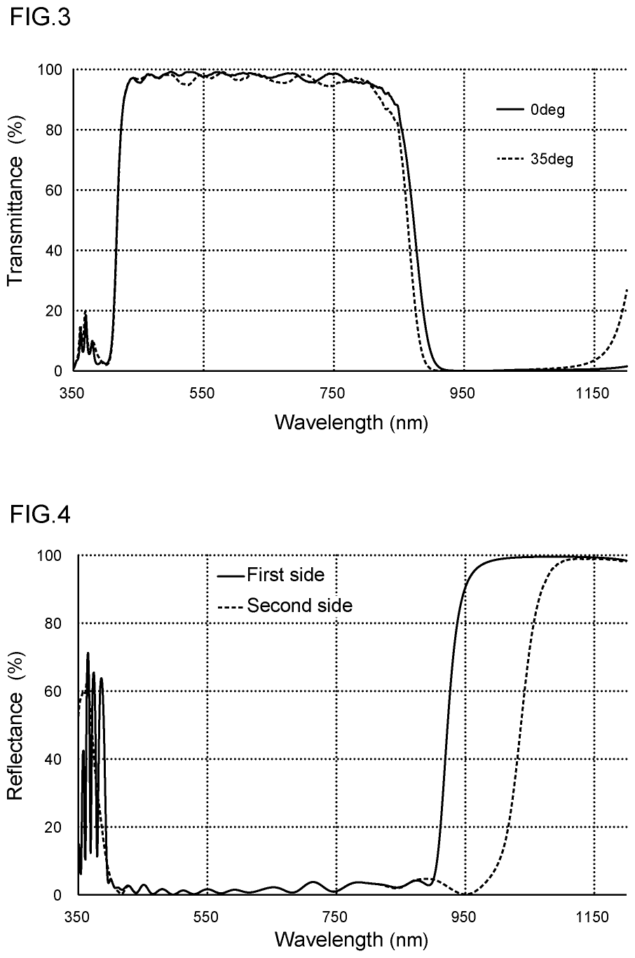

Regarding the optical filter of Experimental Example 8, the spectral transmittance curves at an angle of incidence of 0 degrees (0deg) and an angle of incidence of 35 degrees (35deg) are illustrated in FIG. 3, and the spectral reflectance curves at an angle of incidence of 5 degrees in a case in which the first dielectric multilayer film side (first side) and the second dielectric multilayer film side (second side) are the direction of incidence side are illustrated in FIG. 4.

TABLE 12

| | | Experimental | Experimental | Experimental | Experimental | Experimental |
|---|---|---|---|---|---|---|
| | unit | Example 1 | Example 2 | Example 3 | Example 4 | Example 5 |
| T[450-800(0deg)AVE] | % | 98.0 | 97.9 | 97.9 | 96.6 | 98.0 |
| T[830-860(0deg)MAX] | % | 96.6 | 93.5 | 93.7 | 4.6 | 92.5 |
| T[930-960(0deg)MIN] | % | 7.00 | 0.41 | 0.40 | 0.19 | 0.03 |
| T[830-860(35deg)MAX] | % | 91.7 | 88.2 | 91.4 | 0.6 | 87.3 |
| T[930-960(35deg)MIN] | % | 0.550 | 0.021 | 0.023 | 0.355 | 0.004 |
| RI[930-960(5deg)AVE]FSR | % | 44.15 | 10.70 | 9.70 | 99.81 | 89.74 |
| RI[930-960(5deg)AVE]BSR | % | 3.84 | 0.51 | 4.58 | 99.57 | 0.55 |
| IR50_{L}(0deg) | nm | 896.6 | 872.6 | 873.0 | 798.7 | 872.3 |
| IR50_{L}(35deg) | nm | 885.8 | 871.9 | 871.4 | 756.4 | 859.1 |
| OD[930-960(0deg)] | — | 1.15 | 2.39 | 2.40 | 2.72 | 3.54 |
| OD[930-960(35deg)] | — | 2.26 | 3.68 | 3.63 | 2.45 | 4.35 |
| \|IR50_{L}(0deg)-IR50_{L}(35deg)\| | nm | 10.8 | 0.7 | 1.5 | 42.3 | 13.2 |
| \|T[830-860(0deg)MAX]- | % | 4.9 | 5.3 | 2.3 | 4.0 | 5.2 |
| T[830-860(35deg)MAX]\| | | | | | | |
| \|OD[930-960(0deg)]- | — | 1.10 | 1.28 | 1.23 | 0.27 | 0.81 |
| OD[930-960(35deg)]\| | | | | | | |
| Glass Composition | — | Yb Glass | Yb Glass | Yb Glass | Glass | Yb Glass |
| | | Substrate 1 | Substrate 2 | Substrate 2 | Substrate 3 | Substrate 2 |
| Glass Plate Thickness | mm | 0.2 | 0.8 | 0.8 | 0.2 | 0.8 |
| IR50_{S}(0deg) | nm | 416.9 | 417.1 | 403.7 | 416.9 | 417.0 |
| IR50_{S}(35deg) | nm | 417.3 | 417.4 | 389.1 | 417.3 | 417.4 |
| \|IR50_{S}(0deg)-IR50_{S}(35deg)\| | nm | 0.34 | 0.25 | 14.61 | 0.36 | 0.33 |

| | | Experimental | Experimental | Experimental | Experimental |
|---|---|---|---|---|---|
| | unit | Example 6 | Example 7 | Example 8 | Example 9 |
| T[450-800(0deg)AVE] | % | 98.0 | 98.0 | 98.0 | 98.0 |
| T[830-860(0deg)MAX] | % | 94.4 | 92.3 | 92.3 | 99.3 |
| T[930-960(0deg)MIN] | % | 0.02 | 0.09 | 0.04 | 28.85 |
| T[830-860(35deg)MAX] | % | 88.2 | 87.5 | 87.0 | 97.4 |
| T[930-960(35deg)MIN] | % | 0.004 | 0.008 | 0.005 | 2.646 |
| RI[930-960(5deg)AVE]FSR | % | 93.48 | 65.22 | 84.21 | 43.29 |
| RI[930-960(5deg)AVE]BSR | % | 0.55 | 0.55 | 0.55 | 43.19 |
| IR50_{L}(0deg) | nm | 872.6 | 872.7 | 872.4 | 948.1 |
| IR50_{L}(35deg) | nm | 856.4 | 868.9 | 863.1 | 895.6 |
| OD[930-960(0deg)] | — | 3.71 | 3.06 | 3.38 | 0.54 |
| OD[930-960(35deg)] | — | 4.42 | 4.12 | 4.28 | 1.58 |
| \|IR50_{L}(0deg)-IR50_{L}(35deg)\| | nm | 16.2 | 3.8 | 9.3 | 52.5 |
| \|T[830-860(0deg)MAX]- | % | 6.1 | 4.8 | 5.3 | 1.9 |
| T[830-860(35deg)MAX]\| | | | | | |
| \|OD[930-960(0deg)]- | — | 0.71 | 1.07 | 0.90 | 1.04 |
| OD[930-960(35deg)]\| | | | | | |
| Glass Composition | — | Yb Glass | Yb Glass | Yb Glass | Glass |
| | | Substrate 2 | Substrate 2 | Substrate 2 | Substrate 3 |
| Glass Plate Thickness | mm | 0.8 | 0.8 | 0.8 | 0.2 |
| IR50_{S}(0deg) | nm | 417.0 | 417.1 | 417.1 | 416.9 |
| IR50_{S}(35deg) | nm | 417.4 | 417.4 | 417.4 | 417.3 |
| \|IR50_{S}(0deg)-IR50_{S}(35deg)\| | nm | 0.44 | 0.30 | 0.32 | 0.28 |

It can be said that the optical filters of Experimental Examples 5 to 8 are optical filters that satisfy all of the spectral characteristics (I-i) to (I-v), have at least one of RI[930-960(5deg)AVE]FSR and RI[930-960(5deg)AVE]BSR of 60% or more, are excellent in transmissivity of visible light and near-infrared light in the vicinity of 850 nm, are excellent in blocking performance of near-infrared light in the vicinity of 940 nm, and have a small shift amount of a spectral curve even at a high angle of incidence.

Meanwhile, the optical filters of Experimental Examples 1 to 4 and 9 were optical filters that did not satisfy any of the spectral characteristics (I-ii) to (I-v), and were inferior in transmissivity of near-infrared light in the vicinity of 850 nm or inferior in the blocking performance of near-infrared light in the vicinity of 940 nm.

### REFERENCE SIGNS LIST

1A and 1B Optical filter
11 Yb glass substrate
12 Resin film
20A, 20B and 20C dielectric multilayer film

1. An optical filter, comprising, in this order: a first dielectric multilayer film; an ytterbium-containing glass substrate; and a second dielectric multilayer film, the optical filter satisfying the following spectral characteristics (I-i) to (I-v):
(I-i) an average transmittance T[450-800(0deg)AVE] at wavelengths of from 450 to 800 nm in a spectral transmittance curve at an angle of incidence of 0 degrees is 90% or more,
(I-ii) a maximum transmittance T[830-860(0deg)MAX] at wavelengths of from 830 to 860 nm in a spectral transmittance curve at an angle of incidence of 0 degrees is 80% or more,
(I-iii) a maximum transmittance T[830-860 (35deg)MAX] at wavelengths of from 830 to 860 nm in a spectral transmittance curve at an angle of incidence of 35 degrees is 80% or more,
(I-iv) a minimum transmittance T[930-960(0deg)MIN] at wavelengths of from 930 to 960 nm in a spectral transmittance curve at an angle of incidence of 0 degrees is 0.2% or less, and
(I-v) a minimum transmittance T[930-960 (35deg)MIN] at wavelengths of from 930 to 960 nm in a spectral transmittance curve at an angle of incidence of 35 degrees is 0.2% or less,
wherein, in a case in which at least one of a first dielectric multilayer film side or a second dielectric multilayer film side is a direction of incidence side, in a spectral reflectance curve at an angle of incidence of 5 degrees, an average reflectance RI[930-960(5deg)AVE] at wavelengths of from 930 to 960 nm is 60% or more.

2. The optical filter according to claim 1, satisfying the following spectral characteristics (I-vi) and (I-vii):
(I-vi) in a spectral transmittance curve at an angle of incidence of 0 degrees, a wavelength IR50_{L}(0deg) at which a transmittance is 50% is in a range of from 860 to 900 nm, and
(I-vii) in a spectral transmittance curve at an angle of incidence of 35 degrees, a wavelength IR50_{L}(35deg) at which a transmittance is 50% is in a range of from 850 to 900 nm.

3. The optical filter according to claim 2, wherein an absolute value of a difference between IR50_{L}(0deg) and IR50_{L}(35deg) is 20 nm or less.

4. The optical filter according to claim 1, wherein, in a case in which at least one of the first dielectric multilayer film side or the second dielectric multilayer film side is the direction of incidence side, in a spectral reflectance curve at an angle of incidence of 5 degrees, an average reflectance RI[930-960(5deg)AVE] at wavelengths of from 930 to 960 nm is 80% or more.

5. The optical filter according to claim 1, wherein an absolute value of a difference between T[830-860(0deg)MAX] and T[830-860 (35deg)MAX] is 10% or less.

6. The optical filter according to claim 1, wherein an absolute value of a difference between a minimum optical density OD[930-960(0deg)] at wavelengths of from 930 to 960 nm at an angle of incidence of 0 degrees and a minimum optical density OD[930-960 (35deg)] at wavelengths of from 930 to 960 nm at an angle of incidence of 35 degrees, is 1.00 or less.

7. The optical filter according to claim 1, wherein the ytterbium-containing glass substrate contains, in terms of mol % on an oxide basis, from 0.1 to 50 mol % of SiO₂, from 15 to 40 mol % of B₂O₃, from 0 to 15 mol % of P₂O₅, and from 20 to 60 mol % of Yb₂O₃.

8. The optical filter according to claim 1, wherein a thickness of the ytterbium-containing glass substrate is from 0.4 to 1.0 mm.

9. The optical filter according to claim 1, further comprising: a resin layer containing a dye having a maximum absorption wavelength of from 370 to 440 nm between the ytterbium-containing glass substrate and the second dielectric multilayer film.

10. The optical filter according to claim 9, wherein:
a wavelength IR50ₛ(0deg) at which a transmittance is 50% falls within a range of from 390 to 440 nm in a spectral transmittance curve at an angle of incidence of 0 degrees,
a wavelength IR50ₛ(35deg) at which a transmittance is 50% falls within a range of from 390 to 440 nm in a spectral transmittance curve at an angle of incidence of 35 degrees, and
an absolute value of a difference between IR50ₛ(0deg) and IR50ₛ(35deg) is 2 nm or less.

11. An imaging device, comprising the optical filter according to claim 1.
